(19) United States
(12) Patent Application Publication
(10) Pub. No.: US 2017/0221118 A1
(43) Pub. Date: Aug. 3, 2017

(54) SYSTEMS AND METHODS FOR UNDERSTANDING SEARCH QUERIES

(71) Applicant: Wal-Mart Stores, Inc., Bentonville, AR (US)

(72) Inventors: Manas Pathak, Sunnyvale, CA (US); Seshadri Sridharan, Mountain View, CA (US)

(73) Assignee: Wal-Mart Stores, Inc., Bentonville, AR (US)

(21) Appl. No.: 15/011,499

(22) Filed: Jan. 30, 2016

(51) Int. Cl. G06Q 30/06; G06F 17/30

(52) U.S. Cl. CPC G06Q 30/0623; G06F 17/30669; G06F 17/30654; G06F 17/30696

(57) ABSTRACT

In some embodiments, a method can comprise receiving a search query for an item in a product catalog, the product catalog comprising one or more items and determining that a language of the search query is an unselected language. In many embodiments, the method can further comprise translating the search query into a selected language, performing a search of the search query based on the translation of the search query into the selected language, the search comprising search results in the selected language and the search results comprising at least a portion of the product catalog, and facilitating display of the search results in the selected language. Other embodiments of related methods and systems are also provided.

### TECHNICAL FIELD

This disclosure relates generally to systems and methods for understanding product queries, and relates more particularly to systems to determine a language of the query and translate the query into a selected language, and related methods.

### BACKGROUND

There are many customers who speak more than one language, and/or who live in a region with a primary language different from their native language. When interacting with a search engine for an electronic commerce (eCommerce) website, these customers can prefer to write search queries in their native language, or in a different language. Many times, the search engine of an eCommerce website is unable to perform, or accurately perform, a search based on a search query in a different language than the language primarily used in the region of the eCommerce website, in part because the search engine does not understand the search query. Accordingly, there is a need for systems and methods to provide better understanding of search queries.

### BRIEF DESCRIPTION OF THE DRAWINGS

To facilitate further description of the embodiments, the following drawings are provided in which:

FIG. 1 illustrates a front elevation view of a computer system that is suitable for implementing at least part of a central computer system;

FIG. 2 illustrates a representative block diagram of exemplary elements included on the circuit boards inside a chassis of the computer system of FIG. 1;

FIG. 3 illustrates a representative block diagram of a system, according to an embodiment;

FIG. 4 is a flowchart for a method, according to an embodiment;

FIG. 5 illustrates a flowchart for a translation method, according to an embodiment;

FIG. 6 is a flowchart for a method, according to another embodiment;

FIG. 7 is a flowchart for another method, according to an embodiment; and

FIG. 8 illustrates a representative block diagram of a portion of the system of FIG. 3, according to an embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### Description of Examples of Embodiments

Some embodiments can include a system. In many embodiments, the system can comprise one or more processing modules and one or more non-transitory storage modules storing computing instructions configured to run on the one or more processing modules and perform the acts. In many embodiments, the acts can comprise receiving a search query for an item in a product catalog, the product catalog comprising one or more items, determining that a language of the search query is an unselected language, and translating the search query into a selected language. In some embodiments, the acts can further comprise performing a search of the search query based on the translation of the search query into the selected language, the search comprising search results in the selected language and the search results comprising at least a portion of the product catalog and facilitating display of the search results in the selected language.

Some embodiments include a method. In some embodiments, a method can comprise receiving a search query for an item in a product catalog, the product catalog comprising one or more items and determining that a language of the search query is an unselected language. In many embodiments, the method can further comprise translating the search query into a selected language, performing a search of the search query based on the translation of the search query into the selected language, the search comprising search results in the selected language and the search results comprising at least a portion of the product catalog, and facilitating display of the search results in the selected language.

Various embodiments of systems and methods for understanding product queries can include a method comprising determining that a language of a search query is an unselected language and translating the search query into a selected language. In many embodiments, the method can further comprise determining whether the language of the search query is a brand name of any of the one or more items, if the language of the search query is not the brand name of any of the one or more items, performing a search of the search query based on the translation of the search query into the selected language, the search comprising search results in the selected language and the search results comprising at least a portion of the product catalog, and facilitating display of the search results in the selected language.

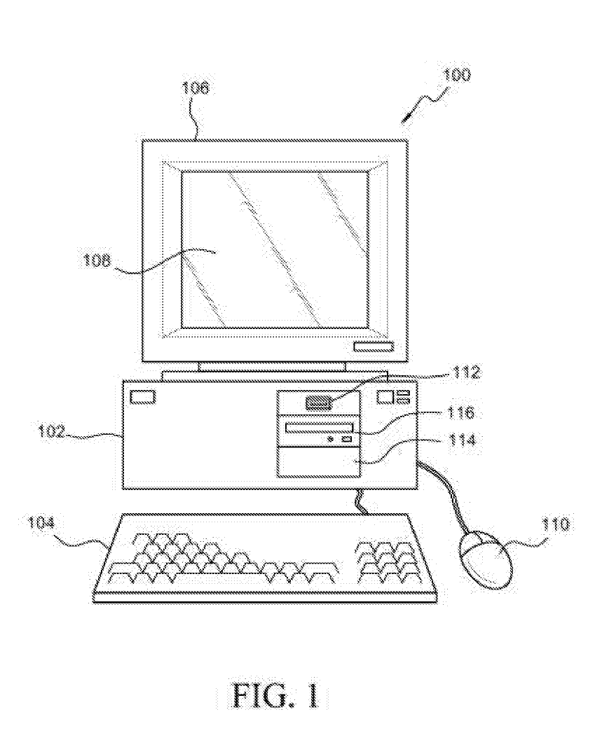

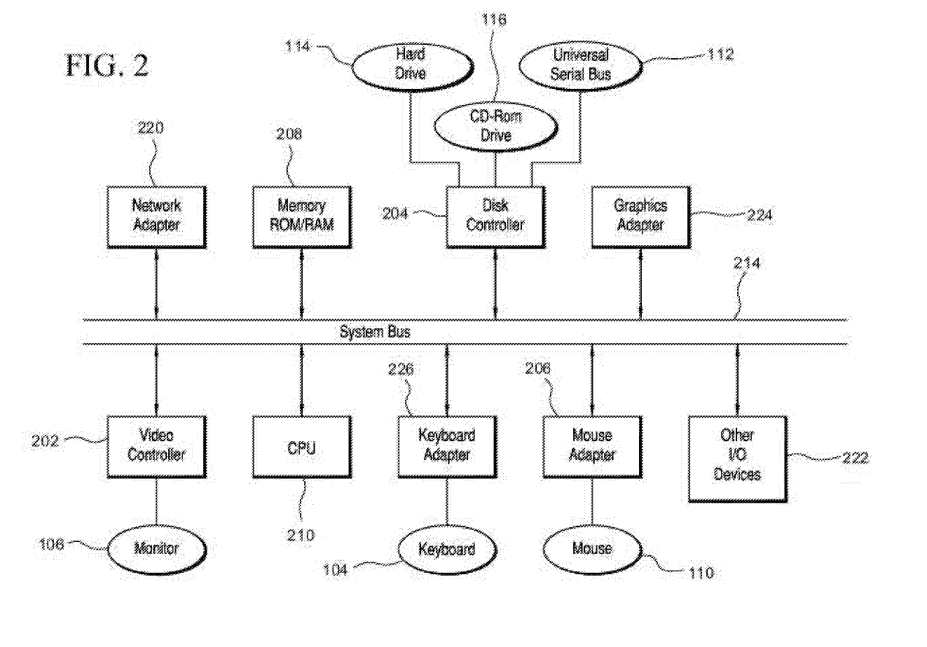

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the memory storage modules described herein. As an example, a different or separate one of a chassis 102 (and its internal components) can be suitable for implementing part or all of one or more embodiments of the techniques, methods, and/or systems described herein. Furthermore, one or more elements of computer system 100 (e.g., a monitor 106, a keyboard 104, and/or a mouse 110, etc.) also can be appropriate for implementing part or all of one or more embodiments of the techniques, methods, and/or systems described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 can comprise (i) volatile (e.g., transitory) memory, such as, for example, read only memory (ROM) and/or (ii) non-volatile (e.g., non-transitory) memory, such as, for example, random access memory (RAM). The non-volatile memory can be removable and/or non-removable non-volatile memory. Meanwhile, RAM can include dynamic RAM (DRAM), static RAM (SRAM), etc. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. The memory storage module(s) of the various embodiments disclosed herein can comprise memory storage unit 208, an external memory storage drive (not shown), such as, for example, a USB-equipped electronic memory storage drive coupled to universal serial bus (USB) port 112 (FIGS. 1-2), hard drive 114 (FIGS. 1-2), CD-ROM and/or DVD drive 116 (FIGS. 1-2), a floppy disk drive (not shown), an optical disc (not shown), a magneto-optical disc (now shown), magnetic tape (not shown), etc. Further, non-volatile or non-transitory memory storage module(s) refer to the portions of the memory storage module(s) that are non-volatile (e.g., non-transitory) memory.

In various examples, portions of the memory storage module(s) of the various embodiments disclosed herein (e.g., portions of the non-volatile memory storage module(s)) can be encoded with a boot code sequence suitable for restoring computer system 100 (FIG. 1) to a functional state after a system reset. In addition, portions of the memory storage module(s) of the various embodiments disclosed herein (e.g., portions of the non-volatile memory storage module(s)) can comprise microcode such as a Basic Input-Output System (BIOS) operable with computer system 100 (FIG. 1). In the same or different examples, portions of the memory storage module(s) of the various embodiments disclosed herein (e.g., portions of the non-volatile memory storage module(s)) can comprise an operating system, which can be a software program that manages the hardware and software resources of a computer and/or a computer network. The BIOS can initialize and test components of computer system 100 (FIG. 1) and load the operating system. Meanwhile, the operating system can perform basic tasks such as, for example, controlling and allocating memory, prioritizing the processing of instructions, controlling input and output devices, facilitating networking, and managing files. Exemplary operating systems can comprise one of the following: (i) Microsoft® Windows® operating system (OS) by Microsoft Corp. of Redmond, Wash., United States of America, (ii) Mac® OS X by Apple Inc. of Cupertino, Calif., United States of America, (iii) UNIX® OS, and (iv) Linux® OS. Further exemplary operating systems can comprise one of the following: (i) the iOS® operating system by Apple Inc. of Cupertino, Calif., United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, Calif., United States of America, (v) the Windows Mobile™ operating system by Microsoft Corp. of Redmond, Wash., United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processing modules of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1-2) and mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM drive 116 (FIGS. 1-2). In other embodiments, distinct units can be used to control each of these devices separately.

Network adapter 220 can be suitable to connect computer system 100 (FIG. 1) to a computer network by wired communication (e.g., a wired network adapter) and/or wireless communication (e.g., a wireless network adapter). In some embodiments, network adapter 220 can be plugged or coupled to an expansion port (not shown) in computer system 100 (FIG. 1). In other embodiments, network adapter 220 can be built into computer system 100 (FIG. 1). For example, network adapter 220 can be built into computer system 100 (FIG. 1) by being integrated into the motherboard chipset (not shown), or implemented via one or more dedicated communication chips (not shown), connected through a PCI (peripheral component interconnector) or a PCI express bus of computer system 100 (FIG. 1) or USB port 112 (FIG. 1).

Returning now to FIG. 1, although many other components of computer system 100 are not shown, such components and their interconnection are well known to those of ordinary skill in the art. Accordingly, further details concerning the construction and composition of computer system 100 and the circuit boards inside chassis 102 are not discussed herein.

Meanwhile, when computer system 100 is running, program instructions (e.g., computer instructions) stored on one or more of the memory storage module(s) of the various embodiments disclosed herein can be executed by CPU 210 (FIG. 2). At least a portion of the program instructions, stored on these devices, can be suitable for carrying out at least part of the techniques and methods described herein.

Further, although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile electronic device, such as a smartphone. In certain additional embodiments, computer system 100 may comprise an embedded system.

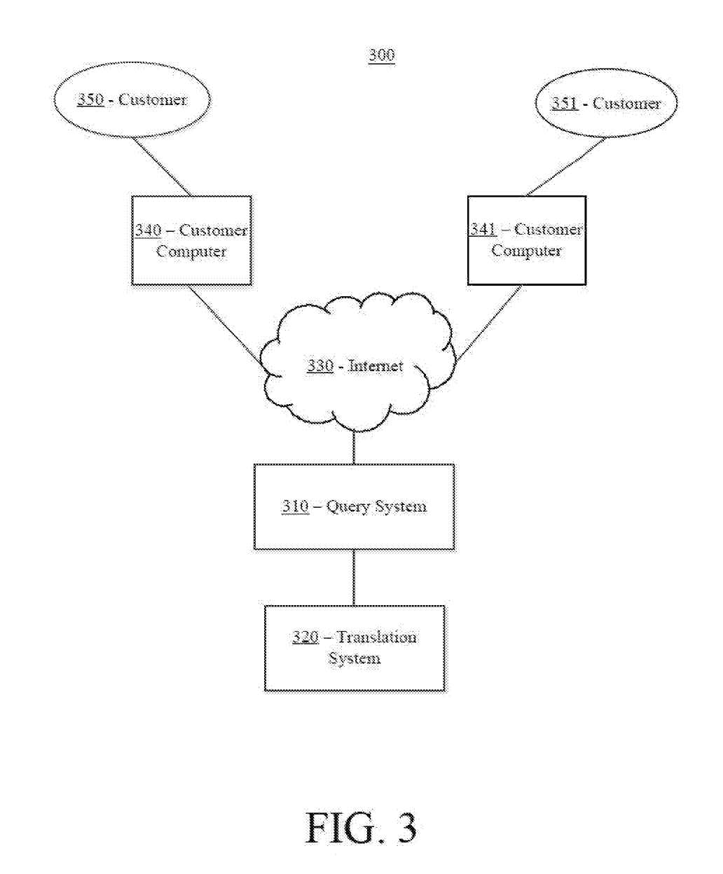

Skipping ahead now in the drawings, FIG. 3 illustrates a representative block diagram of a system 300, according to an embodiment. System 300 is merely exemplary and embodiments of the system are not limited to the embodiments presented herein. System 300 can be employed in many different embodiments or examples not specifically depicted or described herein. In some embodiments, certain elements or modules of system 300 can perform various methods and/or activities of those methods. In these or other embodiments, the methods and/or the activities of the methods can be performed by other suitable elements or modules of system 300.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In a number of embodiments, system 300 can comprise a query system 310 and a translation system 320. In some embodiments, query system 310 and translation system 320 can each be a computer system 100 (FIG. 1), as described above, and can each be a single computer, a single server, or a cluster or collection of computers or servers. In some embodiments, query system 310 can be in communication with an inventory system (not shown) which can track distinct items (e.g., stock keeping units (SKUs)) in a product catalog, which can be ordered through the online retailer and which can be housed at one or more warehouses. In many embodiments, warehouses can comprise brick-and-mortar stores, distribution centers, or other storage facilities.

In many embodiments, query system 310 and/or translation system 320 can each comprise one or more input devices (e.g., one or more keyboards, one or more keypads, one or more pointing devices such as a computer mouse or computer mice, one or more touchscreen displays, microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to the processing module(s) and/or the memory storage module(s) of query system 310 and/or translation system 320 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processing module(s) and/or the memory storage module(s). In some embodiments, the KVM switch also can be part of query system 310 and/or translation system 320. In a similar manner, the processing module(s) and the memory storage module(s) can be local and/or remote to each other.

In many embodiments, query system 310 can be configured to communicate with one or more customer computers 340 and 341. In some embodiments, customer computers 340 and 341 also can be referred to as user computers. In some embodiments, query system 310 can communicate or interface (e.g. interact) with one or more customer computers (such as customer computers 340 and 341) through a network or internet 330. Internet 330 can be an intranet that is not open to the public. Accordingly, in many embodiments, query system 310 can refer to a back end of system 300 operated by an operator and/or administrator of system 300, and customer computers 340 and 341 can refer to a front end of system 300 used by one or more customers 350 and 351, respectively. In some embodiments, customers 350 and 351 also can be referred to as users. In these or other embodiments, the operator and/or administrator of system 300 can manage order system 300, the processing module(s) of order system 300, and/or the memory storage module(s) of order system 300 using the input device(s) and/or display device(s) of order system 300.

Meanwhile, in many embodiments, query system 310 and translation system 320 also can be configured to communicate with one or more databases. The one or more database can comprise a product database that contains information about products sold by a retailer. The one or more databases can be stored on one or more memory storage modules (e.g., non-transitory memory storage module(s)), which can be similar or identical to the one or more memory storage module(s) (e.g., non-transitory memory storage module(s)) described above with respect to computer system 100 (FIG. 1). Also, in some embodiments, for any particular database of the one or more databases, that particular database can be stored on a single memory storage module of the memory storage module(s) and/or the non-transitory memory storage module(s) storing the one or more databases or the contents of that particular database can be spread across multiple ones of the memory storage module(s) and/or non-transitory memory storage module(s) storing the one or more databases, depending on the size of the particular database and/or the storage capacity of the memory storage module(s) and/or non-transitory memory storage module(s).

The one or more databases each can comprise a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, communication between query system 310, translation system 320, and/or the one or more databases can be implemented using any suitable manner of wired and/or wireless communication. Accordingly, system 300 can comprise any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can comprise Bluetooth, Zigbee, Wireless Universal Serial Bus (USB), Z-Wave, etc.; exemplary LAN and/or WAN protocol(s) can comprise Institute of Electrical and Electronic Engineers (IEEE) 802.3 (also known as Ethernet), IEEE 802.11 (also known as WiFi), etc.; and exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can comprise wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can comprise wireless communication hardware including, for example, one or more radio transceivers, one or more infrared transceivers, etc. Additional exemplary communication hardware can comprise one or more networking components (e.g., modulator-demodulator components, gateway components, etc.)

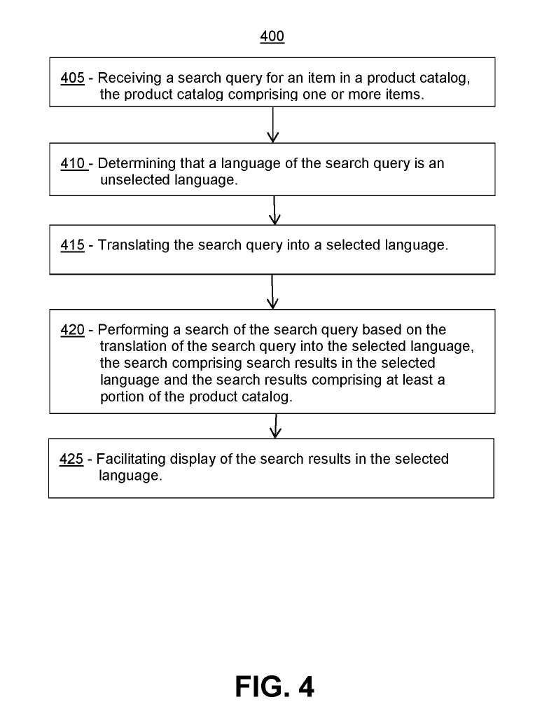

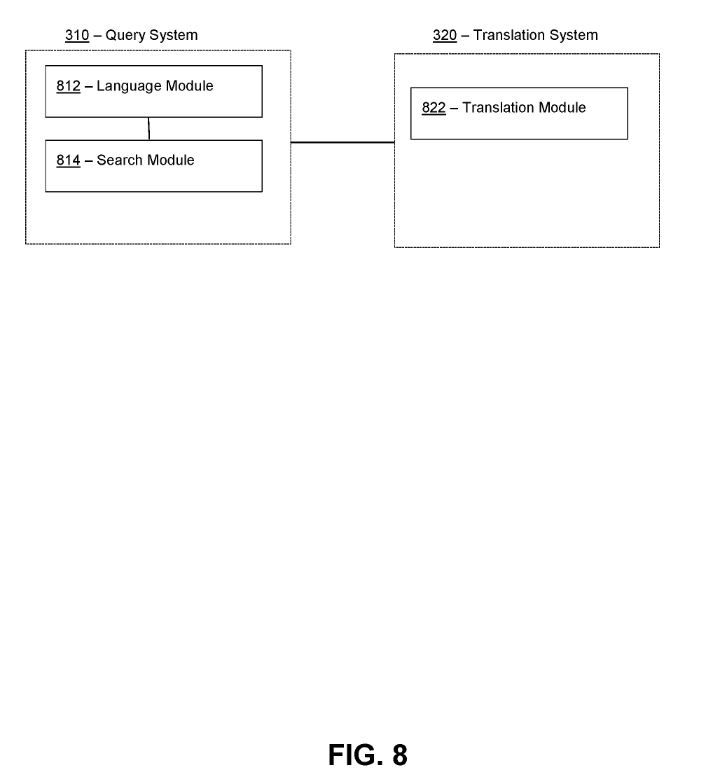

Turning ahead in the drawings, FIG. 4 illustrates a flow chart for a method 400, according to an embodiment. Method 400 is merely exemplary and is not limited to the embodiments presented herein. Method 400 can be employed in many different embodiments or examples not specifically depicted or described herein. In some embodiments, the activities of method 400 can be performed in the order presented. In other embodiments, the activities of method 400 can be performed in any suitable order. In still other embodiments, one or more of the activities of method 400 can be combined or skipped. In many embodiments, system 300 (FIG. 3) can be suitable to perform method 400 and/or one or more of the activities of method 400. In these or other embodiments, one or more of the activities of method 400 can be implemented as one or more computer instructions configured to run at one or more processing modules and configured to be stored at one or more non-transitory memory storage modules 812, 814, or 822 (FIG. 8). Such non-transitory memory storage modules can be part of a computer system such as query system 310 (FIG. 3) and/or translation system 320 (FIG. 3). The processing module(s) can be similar or identical to the processing module(s) described above with respect to computer system 100 (FIG. 1).

Method 400 can comprise an activity 405 of receiving a search query for an item in a product catalog. In many embodiments, the product catalog can comprise one or more items (e.g., SKUs). In many embodiments, the product catalog can comprise one or more items, and the one or more items are not tagged with unselected language equivalents. In many embodiments, method 400 can further comprise an activity 410 of determining that a language of the search query is an unselected language. An unselected language (e.g., a foreign language) can be a language other than a default language of the eCommerce website, a non-primary or uncommon language of the country and/or region the eCommerce website serves (e.g., a language other than English for an eCommerce website in the United States), and/or a language that is not selected as the search language by the eCommerce website administrator.

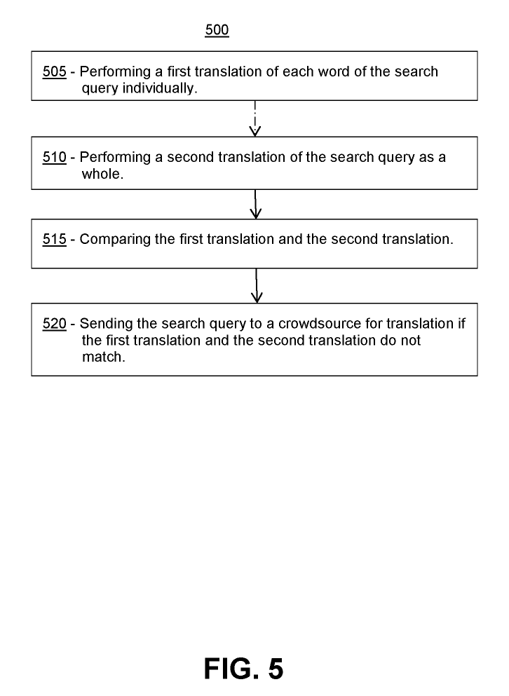

In some embodiments, method 400 can further comprise an activity 415 of translating the search query into a selected language. In many embodiments, the selected language can comprise the default language of the eCommerce website, a primary or common language of the country and/or region the eCommerce website serves (e.g., English for an eCommerce website in the United States), and/or a language that is selected as the search language by the eCommerce website administrator. In some embodiments, activity 415 of translating the search query into the selected language can comprise obtaining translations via crowdsourcing. In many embodiments, crowdsourcing can assist in translating descriptions, phrases, and shortened language (e.g., slang). In some embodiments, crowdsourcing can be used by itself or in combination with machine translation and/or translation by natural language processing. In some embodiments, activity 415 of translating the search query into the selected language can be based at least in part on method 500 as described in FIG. 5.

Turning briefly to FIG. 5, method 500 can comprise an activity 505 of performing a first translation of each word of the search query individually (e.g., translating each word of a phrase independently). In some embodiments, method 500 can further comprise an activity 510 of performing a second translation of the search query as a whole (e.g., translating a phrase while taking each word of the phrase into consideration). In some embodiments, method 500 can further comprise an activity 515 of comparing the first translation and the second translation. In many embodiments, method 500 can further comprise an activity 520 of sending the search query to a crowdsource for translation if the first translation and the second translation do not match. As discussed above, crowdsourcing can assist in translating descriptions, phrases, and shortened language (e.g., slang). In some embodiments, activity 520 of sending the search query to the crowdsource for translation can comprise asking the crowdsource to provide a translation independent of the first and second translations and/or to select the correct translation between the first and second translations. In some embodiments, method 500 can further comprise an activity of translating the product catalog, the product catalog comprising the one or more items. In some embodiments, method 500 can further comprise an activity of providing a product catalog translation lookup table. In many embodiments, the translation of the product catalog can comprise translation through machine translation, natural language processing, and/or crowdsourcing.

Returning to FIG. 4, method 400 can further comprise an activity 420 of performing a search of the search query based on the translation of the search query into the selected language. The search comprises search results in the selected language, and the search results comprises at least a portion of the product language. In many embodiments, the search results for the search query in any unselected language can be the same as the search results for the search query in the selected language.

In many embodiments, method 400 can further comprise an activity 425 of facilitating display of the search results in the selected language. In some embodiments, activity 425 of facilitating display of the search results in the selected language can comprise modifying a display configuration to include the search results in the selected language. In a number of embodiments, method 400 can further comprise an activity of providing an option to view the search results in the unselected language. In some embodiments, a link to a foreign language website of the eCommerce, a link to a translation of the search results in the unselected language, or a link to a search conducted in the unselected language can be provided.

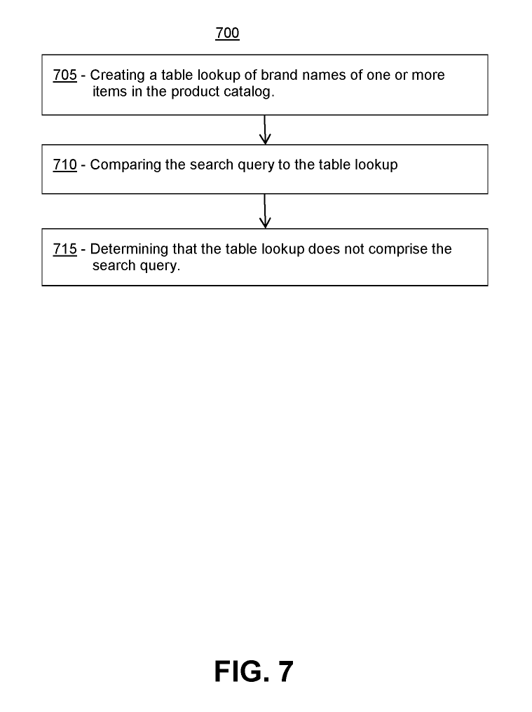

In some embodiments, activity 415 of method 400 can further comprise an activity of determining that the language of the search query is not the brand name of any of the one or more items. In many embodiments, understanding that a search query for a brand name (e.g., DOS EQUIS for a beer, rather than a search for two “x's”) can be treated differently and can result in more accurate search results. In many embodiments, determining that the language of the search query is not the brand name of any of the one or more items can be based at least in part on method 700 as described in FIG. 7.

Turning briefly to ahead in the drawings, FIG. 7 illustrates a method 700.

In many embodiments, method 700 can comprise an activity 705 of creating a table lookup of brand names of one or more items in the product catalog. In some embodiments, method 700 can further comprise an activity 710 of comparing the search query to the table lookup. In a number of embodiments, method 700 can further comprise an activity 715 of determining that the table lookup does not comprise the search query. In some embodiments, activity 700 can comprise determining that the table lookup does comprise the search query.

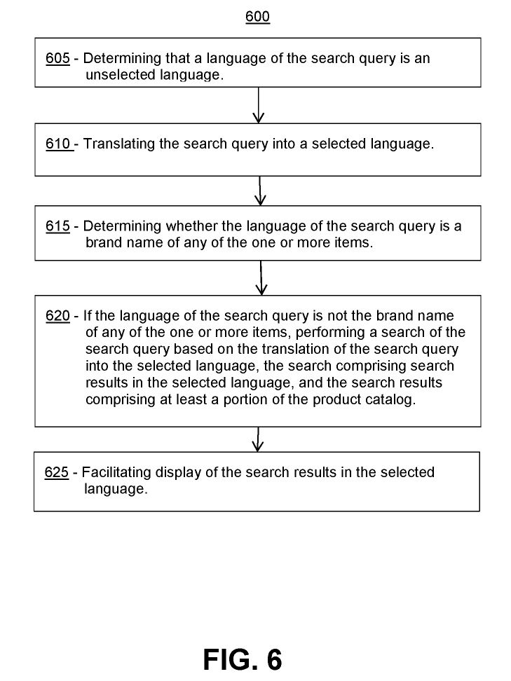

Turning back in the drawings, FIG. 6 illustrates a flow chart for a method 600, according to another embodiment. Method 600 is merely exemplary and is not limited to the embodiments presented herein. Method 600 can be employed in many different embodiments or examples not specifically depicted or described herein. In some embodiments, the activities of method 600 can be performed in the order presented. In other embodiments, the activities of method 600 can be performed in any suitable order. In still other embodiments, one or more of the activities of method 600 can be combined or skipped. In many embodiments, system 300 (FIG. 3) can be suitable to perform method 600 and/or one or more of the activities of method 600. In these or other embodiments, one or more of the activities of method 600 can be implemented as one or more computer instructions configured to run at one or more processing modules and configured to be stored at one or more non-transitory memory storage modules 812, 814, or 822 (FIG. 8). Such non-transitory memory storage modules can be part of a computer system such as query system 310 (FIG. 3) and/or translation system 320 (FIG. 3). The processing module(s) can be similar or identical to the processing module(s) described above with respect to computer system 100 (FIG. 1). In some embodiments, method 600 can be similar to method 400.

In many embodiments, method 600 can comprise an activity 605 of determining that a language of the search query is an unselected language. In some embodiments, activity 605 can be similar to activity 410 (FIG. 4), and vice versa.

Method 600 can further comprise an activity 610 of translating the search query into a selected language. In many embodiments, activity 610 can be similar to activity 415 (FIG. 4), and vice versa.

In a number of embodiments, method 600 can comprise an activity 615 of determining whether the language of the search query is a brand name of any of the one or more items. In some embodiments, activity 615 can be based at least in part on method 700 as described in FIG. 7 above. In a number of embodiments, activity 615 of determining whether the language of the search query is a brand name of any of the one or more items can further comprise creating a table lookup of brand names of one or more items in the product catalog, comparing the search query to the table lookup, and determining that the table lookup does comprise the search query. In some embodiments, activity 615 can comprise determining that the table lookup does not comprise the search query.

In many embodiments, method 600 can comprise an activity 620 of, if the language of the search query is not the brand name of any of the one or more items, performing a search of the search query based on the translation of the search query into the selected language, the search comprising search results in the selected language, and the search results comprising at least a portion of the product catalog. In some embodiments, activity 620 can be similar to activity 420 (FIG. 4), and vice versa.

In various embodiments, method 600 can further comprise an activity 625 of facilitating display of the search results in the selected language. In many embodiments, activity 625 can be similar to activity 425 (FIG. 4), and vice versa.

FIG. 8 illustrates a block diagram of a portion of system 300 comprising query system 310 and translation system 320, according to the embodiment shown in FIG. 3. Query system 310 and translation system 320 each are merely exemplary and are not limited to the embodiments presented herein. Query system 310 and translation system 320 each can be employed in many different embodiments or examples not specifically depicted or described herein. In some embodiments, certain elements or modules of query system 310 and translation system 320 can perform various procedures, processes, and/or acts. In other embodiments, the procedures, processes, and/or acts can be performed by other suitable elements or modules.

In many embodiments, query system 310 can comprise non-transitory memory storage modules 812 and 814, and translation system 320 can comprise a non-transitory memory storage module 822. Memory storage module 812 can be referred to as a language module 812, and memory storage module 814 can be referred to as a search module 814. Memory storage module 822 can be referred to as a translation module 822. In many embodiments, language module 812 can store computing instructions configured to run on one or more processing modules and perform one or more acts of methods 400 (FIG. 4), 500 (FIG. 5), 600 (FIG. 6), and/or 700 (FIG. 7) (e.g., activity 410 of determining that a language of the search query is an unselected language (FIG. 4) or activity 605 of determining that a language of the search query is an unselected language (FIG. 5)). In some embodiments, search module 814 can store computing instructions configured to run on one or more processing modules and perform one or more acts of methods 400 (FIG. 4), 500 (FIG. 5), 600 (FIG. 6), and/or 700 (FIG. 7) (e.g., activity 420 of performing a search of the search query based on the translation of the search query into the selected language, the search comprising search results in the selected language and the search results comprising at least a portion of the product catalog (FIG. 4 or activity 620 of, if the language of the search query is not the brand name of any of the one or more items, performing a search of the search query based on the translation of the search query into the selected language, the search comprising search results in the selected language, and the search results comprising at least a portion of the product catalog (FIG. 5)). In many embodiments, translation module 822 can store computing instructions configured to run on one or more processing modules and perform one or more acts of methods 400 (FIG. 4), 500 (FIG. 5), 600 (FIG. 6), and/or 700 (FIG. 7) (e.g., activity 415 of translating the search query into a selected language (FIG. 4) or activity 615 of determining that the table lookup does not comprise the search query (FIG. 6)).

Although systems and methods for understanding search queries has been described above, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-8 may be modified, and that the foregoing discussion of certain of these embodiments does not necessarily represent a complete description of all possible embodiments. For example, one or more of the activities of FIGS. 3-8 may include different activities and/or be performed by many different modules, in many different orders.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processing modules;
one or more non-transitory storage modules storing computing instructions configured to run on the one or more processing modules and perform the acts of:
receiving a search query for an item in a product catalog, the product catalog comprising one or more items;
determining that a language of the search query is an unselected language;
translating the search query into a selected language;
performing a search of the search query based on the translation of the search query into the selected language, the search comprising search results in the selected language and the search results comprising at least a portion of the product catalog; and
facilitating display of the search results in the selected language.

2. The system of claim 1, wherein:
translating the search query into the selected language comprises obtaining translations via crowdsourcing.

3. The system of claim 1, wherein:
translating the search query into the selected language comprises performing a first translation of each word of the search query individually.

4. The system of claim 3, wherein:
translating the search query into the selected language further comprises:
performing a second translation of the search query as a whole;
comparing the first translation and the second translation; and
sending the search query to a crowdsource for translation if the first translation and the second translation do not match.

5. The system of claim 1, wherein the one or more non-transitory storage modules storing computing instructions are configured to run on the one or more processing modules and further perform the acts of:
determining that the language of the search query is not a brand name of any of the one or more items by:
creating a table lookup of brand names of one or more items in the product catalog;
comparing the search query to the table lookup; and
determining that the table lookup does not comprise the search query.

6. The system of claim 1, wherein:
the search results for the search query in any unselected language is the same as the search results for the search query in the selected language.

7. The system of claim 1, wherein the one or more non-transitory storage modules storing computing instructions are configured to run on the one or more processing modules and further perform the acts of:
translating the product catalog; and
providing a product catalog translation lookup table.

8. The system of claim 1, wherein the one or more non-transitory storage modules storing computing instructions are configured to run on the one or more processing modules and further perform the acts of:
providing an option to view the search results in the unselected language.

9. The system of claim 1, wherein the one or more non-transitory storage modules storing computing instructions are configured to run on the one or more processing modules and further perform the acts of:
determining that the language of the search query is not a brand name of any of the one or more items by:
creating a table lookup of brand names of one or more items in the product catalog;
comparing the search query to the table lookup; and
determining that the table lookup does not comprise the search query;
translating the product catalog;
providing a product catalog translation lookup table; and
providing an option to view the search results in the unselected language;
wherein:
translating the search query into the selected language comprises:
performing a first translation of each word of the search query individually;
performing a second translation of the search query as a whole;
comparing the first translation and the second translation; and
sending the search query to a crowdsource for translation if the first translation and the second translation do not match.
the search results for the search query in any unselected language is the same as the search results for the search query in the selected language.

10. A method comprising:
receiving a search query for an item in a product catalog, the product catalog comprising one or more items;
determining that a language of the search query is an unselected language;
translating the search query into a selected language;
performing a search of the search query based on the translation of the search query into the selected language, the search comprising search results in the selected language and the search results comprising at least a portion of the product catalog; and
facilitating display of the search results in the selected language.

11. The method of claim 10, wherein:
translating the search query into the selected language comprises obtaining translations via crowdsourcing.

12. The method of claim 10, wherein:
translating the search query into the selected language comprises performing a first translation of each word of the search query individually.

13. The method of claim 12, wherein:
translating the search query into a selected language further comprises:
performing a second translation of the search query as a whole;
comparing the first translation and the second translation; and
sending the search query to a crowdsource for translation if the first translation and the second translation do not match.

14. The method of claim 10, further comprising:
determining that the language of the search query is not a brand name of any of the one or more items by:
creating a table lookup of brand names of one or more items in the product catalog;
comparing the search query to the table lookup; and
determining that the table lookup does not comprise the search query.

15. The method of claim 10, wherein:
the search results for the search query in any unselected language is the same as the search results for the search query in the selected language.

16. The method of claim 10, further comprising:
translating the product catalog; and
providing a product catalog translation lookup table.

17. The method of claim 10, wherein:
providing an option to view the search results in the unselected language.

18. The method of claim 10, further comprising:
determining that the language of the search query is not a brand name of any of the one or more items by:
creating a table lookup of brand names of one or more items in the product catalog;
comparing the search query to the table lookup; and
determining that the table lookup does not comprise the search query;
translating the product catalog;
providing a product catalog translation lookup table; and
providing an option to view the search results in the unselected language;
wherein:
translating the search query into the selected language comprises:
performing a first translation of each word of the search query individually;
performing a second translation of the search query as a whole;
comparing the first translation and the second translation; and
sending the search query to a crowdsource for translation if the first translation and the second translation do not match.
the search results for the search query in any unselected language is the same as the search results for the search query in the selected language.

19. A method comprising:
determining that a language of a search query is an unselected language;
translating the search query into a selected language;
determining whether the language of the search query is a brand name of any of the one or more items;
if the language of the search query is not the brand name of any of the one or more items, performing a search of the search query based on the translation of the search query into the selected language, the search comprising search results in the selected language and the search results comprising at least a portion of the product catalog; and
facilitating display of the search results in the selected language.

20. The method of claim 19, wherein:
translating the search query into the selected language comprises obtaining translations via crowdsourcing.

21. The method of claim 19, wherein:
translating the search query into the selected language comprises performing a first translation of each word of the search query individually.

22. The method of claim 21, wherein:
translating the search query into the selected language further comprises:
performing a second translation of the search query as a whole;
comparing the first translation and the second translation; and
sending the search query to a crowdsource for translation if the first translation and the second translation do not match.

23. The method of claim 19, further comprising:
determining whether the language of the search query is a brand name of any of the one or more items by:
creating a table lookup of brand names of one or more items in the product catalog;
comparing the search query to the table lookup; and
determining that the table lookup does not comprise the search query.

24. The method of claim 19, wherein:
the search results for the search query in any unselected language is the same as the search results for the search query in the selected language.

25. The method of claim 10, further comprising:
determining whether the language of the search query is a brand name of any of the one or more items by:
creating a table lookup of brand names of one or more items in the product catalog;
comparing the search query to the table lookup; and
determining that the table lookup does not comprise the search query;
wherein:
translating the search query into the selected language comprises:
performing a first translation of each word of the search query individually;
performing a second translation of the search query as a whole;
comparing the first translation and the second translation; and
sending the search query to a crowdsource for translation if the first translation and the second translation do not match.
the search results for the search query in any unselected language is the same as the search results for the search query in the selected language.
